(19) United States
(12) Patent Application Publication
(10) Pub. No.: US 2005/0123290 A1
(43) Pub. Date: Jun. 9, 2005

(54) Light quantity regulator, optical apparatus and photographing apparatus

(75) Inventors: Tomoki Hasegawa, Tochigi (JP); Akihisa Horiuchi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/991,531

(22) Filed: Nov. 19, 2004

(30) Foreign Application Priority Data
Dec. 8, 2003 (JP) 2003-408507

(51) Int. Cl. G03B 17/26

(52) U.S. Cl. 396/484

(57) ABSTRACT

A light quantity regulator used for an optical apparatus is provided which comprises: a bottom board; two light shielding vanes which form an opening for passing light; and a driving lever connected to the two light shielding vanes, shaft-supported by the bottom board, rotating about the shaft to drive the two light shielding vanes in directions opposite to each other and adjusting the opening area of an opening from an opened state to a closed state, wherein the opening in an opened state has a shape asymmetric to an optical axis.

### BACKGROUND OF THE INVENTION

1. Field of the Invention

The present invention relates to a light quantity regulator used for an optical apparatus (lens apparatus) and photographing apparatus, particularly to a light quantity regulator for regulating light quantity by opening or closing a plurality of light shielding vanes in almost opposite directions.

2. Related Background Art

As a photographing apparatus such as a digital camera or video camera or a light quantity regulator used for an optical apparatus having a lens barrel, there has been a stop apparatus for moving two vanes shown in FIG. 12 in substantially opposite directions to each other when opening or closing the two vanes between opened state and fully closed state. To linearly drive each stop vane, at least two guide shafts are set to the bottom board of the stop apparatus and two guide grooves linearly extending to be engaged with the two guide shafts are formed at the vane side. Therefore, the size of the stop apparatus absolutely increases in the stop-vane driving direction and as a result, the outermost diameter of a photographing lens apparatus mounting the stop apparatus is increased.

Moreover, for a recent photographing lens apparatus, a request for downsizing is greatly raised. Therefore, to downsize the apparatus, the type restraining the size in the vane driving direction (so-called vane-oscillating-type two-vane stop apparatus) is known which has one guide groove by using one guide shaft.

In the case of the stop apparatus having one guide shaft (hereafter referred to as oscillating type), the moving trace of a connecting portion with a light shielding vanes substantially at both ends of a vane driving lever for driving light shielding vanes becomes a circular arc about the lever rotating shaft set substantially at the central portion of the vane driving lever. Moreover, because a guide groove formed on each light shielding vane is linear, both the light shielding vanes are opened or closed between opened state and fully closed state while being followed by a slight rotating motion in the driving face as shown in FIG. 4 and they are driven while oscillating. Therefore, even if shapes of opening forming portions of both the light shielding vanes are set so that the center of gravity of the areas of openings of light passing ports when they are opened coincide with the optical axis, the center of gravity of the areas of light passing ports are deviated from the optical axis when driving them from opening to an intermediate stop region or small stop region. Therefore, uniform ambient light quantity is not obtained from the intermediate stop region to the small stop region and the optical performance is deteriorated.

To solve the above problem, inventions disclosed in Japanese Paten Application Laid-Open No. 2002-72284 and Japanese Patent Application Laid-Open No. 2002-182264 are proposed.

In the case of Japanese Patent Application Laid-Open No. 2002-72284 of a conventional example, it is characterized as shown in FIG. 9 that at least one of guide grooves for moving and guiding set on two light shielding vanes is formed like a curved-line shape. Thereby, by setting the curved-line shape of the guide groove so that the position of the center of gravity of the opening area when the light shielding vanes are driven is kept substantially at a constant position of the optical axis, it is possible to move the light shielding vanes in substantially opposite directions to each other without oscillating the light shielding vanes and make the center of gravity of the opening area substantially coincide with the optical axis or photographing optical axis.

Moreover, as shown in FIG. 11, in the case of the invention of Japanese Patent Application Laid-Open No. 2002-182264 of the above conventional example, the guide shaft set to light shielding vanes is linear and shape of a portion for forming a light passing port in the above two light shielding vanes is set to a shape in which the center of gravity of the area of the light passing port coincides with the optical axis in a range smaller than the opening area and larger than the small stop area of all variable ranges of the area of the light passing port when the two light shielding vanes are opened or closed between an opened state and a fully closed state while oscillating.

However, in the case of the invention disclosed in Japanese Patent Application Laid-Open No. 2002-72284 of the above conventional example, it is possible to keep the position of center of gravity of the opening area substantially at a constant position to the optical axis when light shielding vanes are opened or closed while the opening shape of the light passing port formed by two light shielding vanes while the vanes are opened or closed between opened state and fully closed state becomes a shape asymmetric in the vertical and horizontal directions to the optical axis in the illustrated states as shown in FIGS. 8 and 10.

Moreover, in the case of the invention disclosed in Japanese Patent Application Laid-Open No. 2002-182264 of the above conventional example, the position of center of gravity of the opening area of light shielding vanes when the vanes are opened or closed is kept so as to substantially coincide with the optical axis in the vertical direction under the illustrated state but eccentricity to the optical axis occurs in the horizontal direction. Therefore, the opening shape of the light passing port formed by two light shielding vanes while the vanes are opened or closed between opened state and fully closed state becomes asymmetric to the optical axis in the horizontal direction in the case of the conventional example in FIG. 5 or the illustrated state as shown in FIG. 7.

Even if using a technique for keeping the position of center of gravity of an opening area while conventional light shielding vanes are opened or closed substantially at a constant position to the optical axis, problems occur that uniform light quantity is not obtained on the imaging face of an image pickup apparatus such as a video camera or an optical apparatus having a lens barrel due to an asymmetric opening shape of a light passing port formed by two light shielding vanes to the optical axis while the vanes are opened or closed between an opened state and a fully closed state of the light shielding vanes by these prior arts, the ambient light quantity is unbalanced and the optical performance is deteriorated depending on an image pickup apparatus or a lens apparatus which mounts a stop apparatus.

### SUMMARY OF THE INVENTION

Therefore, it is an object of the present invention to solve the above problems and provide a light quantity regulator, an optical apparatus (lens apparatus) and photographing apparatus capable of eliminating the asymmetry of the opening shape of a light passing port to the optical axis formed by two light shielding vanes or eccentricity of center of gravity of the opening area of the light passing port when the two light shielding vanes are opened or closed between an opened state and a fully closed state and improve optical characteristics.

The present invention provides a light quantity regulator, an optical apparatus (lens apparatus) and a photographing apparatus constituted as described below.

That is, a light quantity regulator of the present invention is a light quantity regulator used for an optical apparatus, including a bottom board, two light shielding vanes which form an opening for passing light and a driving lever connected to the two light shielding vanes and supported to the bottom board by a shaft, which rotates about the shaft and drives the two light shielding vanes in directions opposite to each other so as to adjust an opening area of the opening from an opened state to a closed state, in which the opening in the opened state has a shape asymmetric to an optical axis.

Moreover, it is characterized that an optical apparatus of the present invention has the previously-described light quantity regulator.

Furthermore, it is characterized that a photographing apparatus of the present invention has the previously-described light quantity regulator.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a front view of a light quantity regulator of an embodiment of the present invention;

FIG. 2 is an illustration showing a light shielding vane when a light quantity regulator of an embodiment of the present invention is opened;

FIG. 3 is an exploded perspective view of a light quantity regulator of an embodiment of the present invention;

FIG. 4 is an illustration showing a moving trace of a light shielding vane of an oscillation-type stop apparatus;

FIG. 5 is an illustration showing changes of opening shapes and positions of center of gravity of the opening areas by a light shielding vane of the present invention and a light shielding vane of a conventional light quantity regulator;

FIG. 6 is an illustration showing a change of stop opening shapes by a light quantity regulator of the present invention;

FIG. 7 is an illustration showing a change of stop opening shapes by a conventional light quantity regulator;

FIG. 8 is an illustration showing a change of stop opening shapes by a conventional light quantity regulator;

FIG. 9 is a block diagram (optical-axis directional apparent view) of the stop unit in Japanese Patent Application Laid-Open No. 2002-72284 which is a conventional example;

FIG. 10 is an illustration showing moving traces of components of the stop unit in Japanese Patent Application Laid-Open No. 2002-72284 which is a conventional example;

FIG. 11 is a front view of the light quantity regulator in Japanese Patent Application Laid-Open No. 2002-182264 which is a conventional example;

FIG. 12 a front view of a conventional light quantity regulator;

FIGS. 13A and 13B are sectional views of a zoom lens barrel having a light quantity regulator of an embodiment of the present invention; and

FIG. 14 is a block diagram showing an electric circuit of a photographing apparatus having the zoom lens barrel in the above FIGS. 13A and 13B.

### DESCRIPTION OF THE PREFERRED EMBODIMENTS

It is generally considered to form a portion for forming the apex angle of an opening into a right-and-left-symmetric shape to the optical axis. However, under this configuration, the portion cannot be kept at a position substantially coinciding with the optical axis of center of gravity of the opening area of a light passing port in all regions from opening to small stop regions and the shape of the opening also becomes asymmetric to the optical axis. However, the present invention is constituted so that the opening shape under an opened state is constituted so that it becomes right-and-left asymmetric to the optical axis like the configuration of the embodiment described below and thereby, it is possible to make the optical axis and the center of gravity of the opening area substantially coincide with the optical axis in an intermediate stop region or small stop region from the stop opened state of a stop apparatus and moreover, it is possible to form the opening shape by light shielding vanes into an almost symmetric shape in the horizontal and vertical directions to the optical axis.

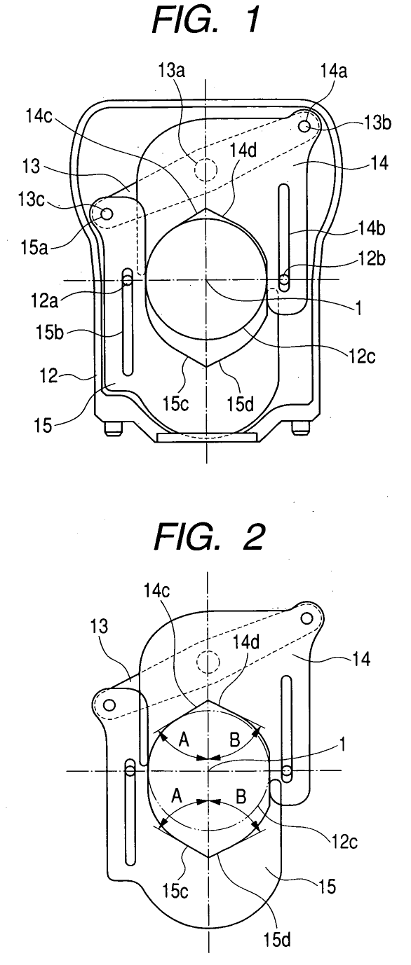

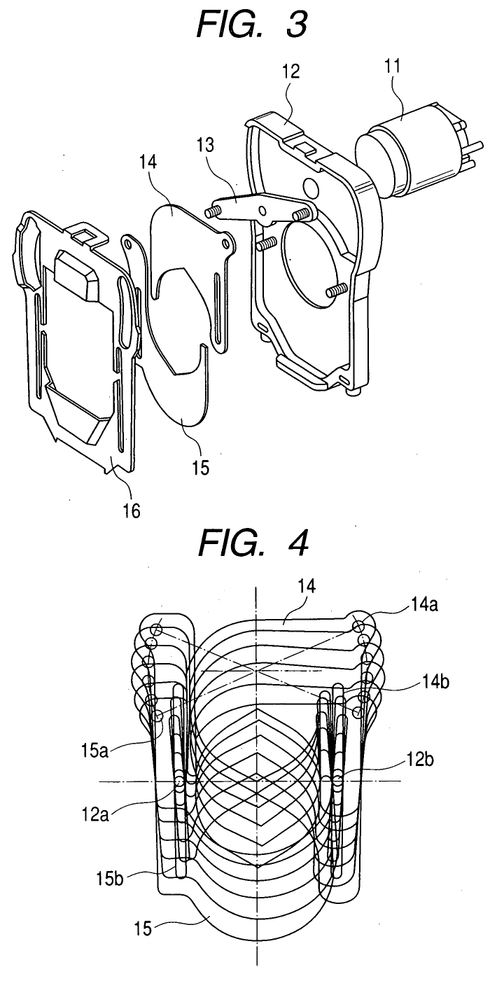

Hereafter, the light quantity regulator of the embodiment of the present invention will be described in detail by referring to the accompanying drawings. FIGS. 1 and 3 show a configuration of the stop apparatus (light quantity regulator) of the embodiment of the present invention. FIG. 2 shows an opening shape when a light shielding vane which is an embodiment of the present invention is opened.

In FIGS. 1 and 3, reference numeral 11 denotes a driving actuator for generating a torque for opening/closing a light shielding vane. The actuator 11 is held by a bottom board 12. A fixed stop 12c is formed on the bottom board 12. The approximately intermediate portion of a light-shielding-vane driving lever 13 is connected to and held by the output shaft of the actuator 11 and reference numeral 13a denotes the rotating shaft of the vane driving lever. Connection shafts 13b and 13c with light shielding vanes are formed substantially at both the ends of the light-shielding-vane driving lever 13.

Reference numeral 14 denotes a first light shielding vane, a connection hole 14a formed on the light shielding vane 14 is rotatably diameter-fitted to the connection shaft 13b of the light-shielding-vane driving lever 13 and thereby the light-shielding-vane driving lever 13 is connected with the light shielding vane 14. Moreover, in FIG. 1, a guide groove (guided portion) 14b vertically linearly extending is formed on the light shielding vane 14 and a guide shaft 12b set to the bottom board 12 is engaged with the guide groove 14b.

Reference numeral 15 denotes a second light shielding vane, a connection hole 15a formed on the light shielding vane 15 is rotatably diameter-fitted to the connection shaft 13c of the light-shielding-vane driving lever 13 and thereby the light-shielding-vane driving lever 13 is connected with the light shielding vane 15. Moreover, in FIG. 3, a guide groove (guided portion) 15b vertically linearly extending is formed on the light shielding vane 15 and a guide shaft 12a set to the bottom board 12 is engaged with the guide groove 15b.

In the case of the stop apparatus thus constituted, by driving the driving actuator 11 and thereby rotating the light-shielding-vane driving lever 13, the first light shielding vane 14 and second light shielding vane 15 connected to the light-shielding-vane driving lever 13 are driven in substantially opposite directions to each other in an optical-axis orthogonal plane or a tilted plane of the orthogonal plane while being movement-guided by engagement between the guide grooves 14b and 15b and the guide shafts 12b and 12a of the bottom board 12. Thereby, the opening area of the light passing port formed by both the light shielding vanes 14 and 15 changes from an opened state to a fully closed state and light quantity is adjusted.

In the case of the stop apparatus, moving traces of the connection shafts 13b and 13c of the light-shielding-vane driving lever 13 and the connection holes 14a and 15a of the light shielding vanes 14 and 15 according to the rotation of the light-shielding-vane driving lever 13 become a circular arc about the rotating shaft 13a of the light-shielding-vane driving lever 13. Because the guide grooves 14b and 15b formed on the light shielding vanes 14 and 15 with which the guide shafts 12b and 12a of the bottom board 12 are engaged linearly extend, the light shielding vanes 14 and 15 are followed by a slight rotating motion about the connecting portions 14a and 15a without performing a linear motion under the opening/closing operations from an opened state to a fully closed state. Therefore, as shown in FIG. 4, the vanes 14 and 15 are opened or closed while they oscillate to change opening shapes of the light passing port.

In the case of the stop apparatus constituted as described above, by forming a portion forming the apex angle of an opening into a right-and-left symmetric shape to the optical axis like the case of the prior art, the portion cannot be kept at a position almost coinciding with the optical axis of center of gravity of the opening area of the light passing port in all regions from opening to small stop regions and the shape of the opening also becomes asymmetric to the optical axis.

These points will be further described by referring to FIG. 2 showing a configuration of an embodiment of the present invention. It is generally considered to form the opening shape of a light shielding vane into a symmetric shape to the optical axis. By equalizing angles of the portions 14c and 14d for forming the apex angle of the opening in the first light shielding vane 14, that is, by making A equal to B, it is generally considered that the opening shape is formed into a right-and-left symmetric shape to the optical axis in the illustrated state in FIG. 2.

In the case of an embodiment of the present invention, however, angles of the portions 14c and 14d forming the apex angle of an opening are made different, that is, they are set so that A is not equal to B. Therefore, the opening shape under an opened state is right-and-left asymmetric to the optical axis in the illustrated state in FIG. 2. The same is applied to the second light shielding vane. Angles of portions 15c and 15d for forming the apex angle of the opening shape are made different, that is, they are set so that A is not equal to B and the opening shape under an opened state is right-and-left asymmetric to the optical axis in the illustrated state in FIG. 2.

By using the above setting, it is possible to make the optical axis and the center of gravity of the opening area substantially coincide with the optical axis in an intermediate stop region or small stop region from an opened state of the stop in the above oscillation-type stop apparatus and moreover form the opening shape by light shielding vanes into a substantial symmetric shape in the horizontal and vertical directions to the optical axis.

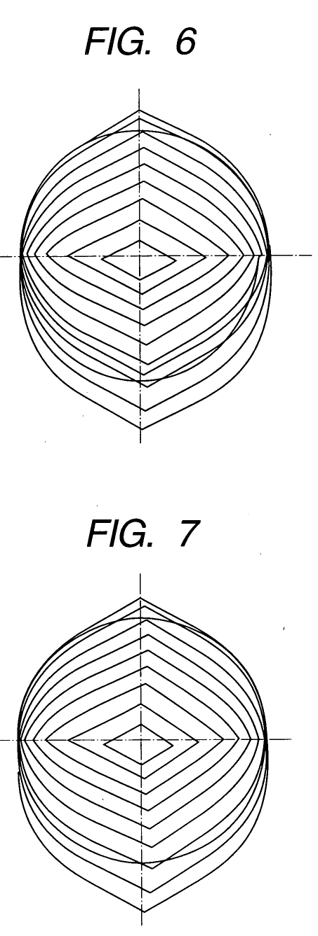

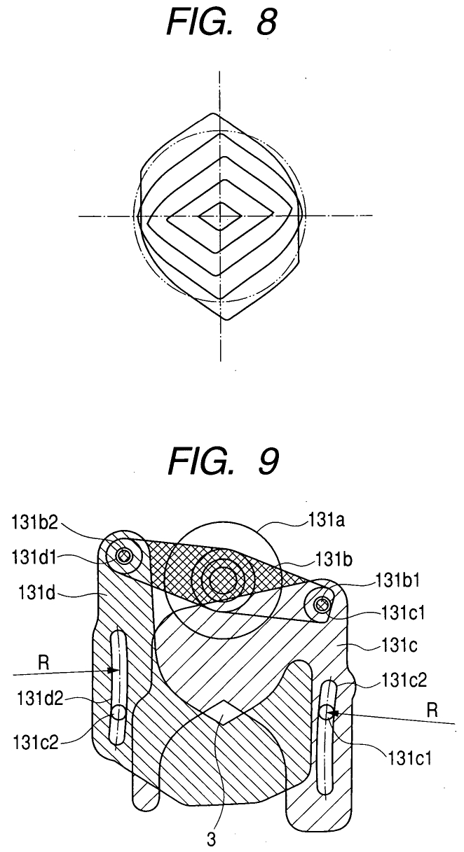

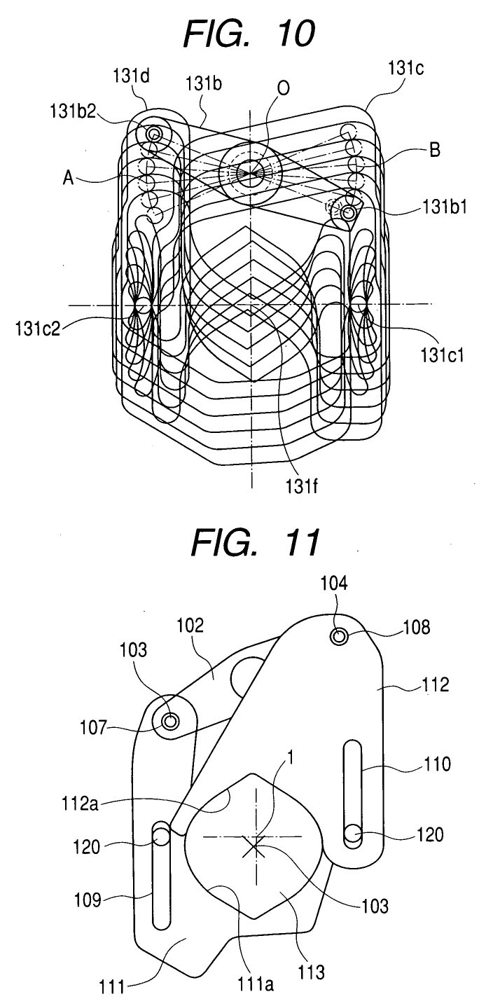

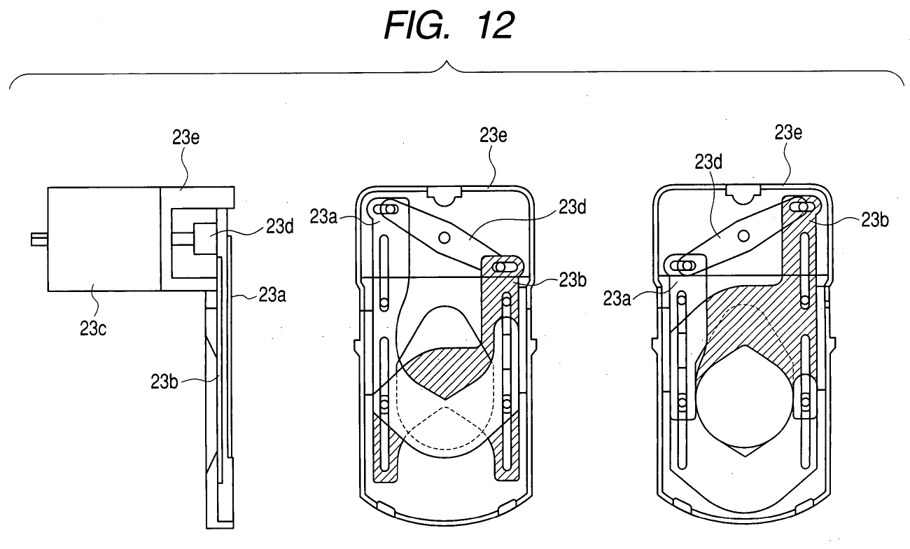

FIG. 6 shows a change of opening shapes of the stop opening of the stop apparatus of this embodiment. In FIGS. 7 and 8 showing the prior art, the opening shape is changed while making the opening shape horizontally or vertically asymmetric to the optical axis. However, in FIG. 6 showing this embodiment, it is possible that the opening shape can obtain a substantial symmetric shape in the vertical and horizontal directions to the optical axis in the range from an intermediate stop region to a small stop region in the illustrated state.

In FIG. 6, the opening shape at the lower side is greatly sheltered from the upper side at the opening side. In fact, however, because a fixed stop formed on a bottom board is present, it can be said that there is no influence of the fixed stop on optical performances.

In the case of the above embodiment of the present invention, the opening shape is formed to be asymmetric to the optical axis for two light shielding vanes. However, it is also allowed to form the opening shape into an asymmetric shape only for either light shielding vane according to necessity.

Moreover, in the case of the above embodiment of the present invention, the shape of the opening of a light shielding vane is set so as to be right-and-left asymmetric to the optical axis in the illustrated state in FIG. 2 under an opened state. However, it is also allowed to obtain the same effect as the above embodiment by setting an opening shape similarly set as ever so that a right-and-left-symmetric light shielding vane tilts in the illustrated state in FIG. 2 when opened.

Moreover, it is preferable that the right-and-left asymmetry of a light shielding vane is kept in a range of 0.5°<|A-B|<10°. Moreover, the asymmetry becomes more preferable when it is kept in a range of 1°<|A-B|<6°.

Furthermore, for a configuration of a stop apparatus, a case is described in which the guide shafts 12a and 12b are set to the bottom board 12 and the guide grooves 14b and 15b are set to the light shielding vanes 14 and 15. However, it is also allowed to set a guide groove to the bottom board 12 and a guide shaft to the light shielding vanes 14 and 15.

Furthermore, a case is described in which the connection shafts 13b and 13c are set to the light-shielding-vane driving lever 13 and the connection holes 14a and 15a are formed on the light shielding vanes 14 and 15. However, it is also allowed to form a connection hole to the light-shielding-vane driving lever 13 and set a connection shaft to the light shielding vanes 14 and 15.

Moreover, specific shapes and structure of portions shown in the above embodiment show embodied examples for executing the present invention.

Though not shown for a configuration of the above stop apparatus, a stop apparatus in which an ND filter is set to any light shielding vane can use the same embodiment.

According to the light quantity regulator of the above embodiment of the present invention, in the case of a so-called oscillation-type stop apparatus in which both light shielding vanes are opened or closed while being followed by a slight rotating motion on the driving plane between an opened state and a fully closed state, it is possible to make the optical axis and center of gravity of the opening area substantially coincide with the optical axis in an intermediate stop region and a small stop region from the opened state of a stop and moreover it is possible to form the opening shape by the light shielding vanes into a substantial symmetric shape in the horizontal and vertical directions to the optical axis. Thereby, it is possible to obtain a uniform ambient light quantity on the imaging plane of an image pickup apparatus such as a video camera or a lens apparatus and realize a light quantity regulator whose optical performances are not deteriorated.

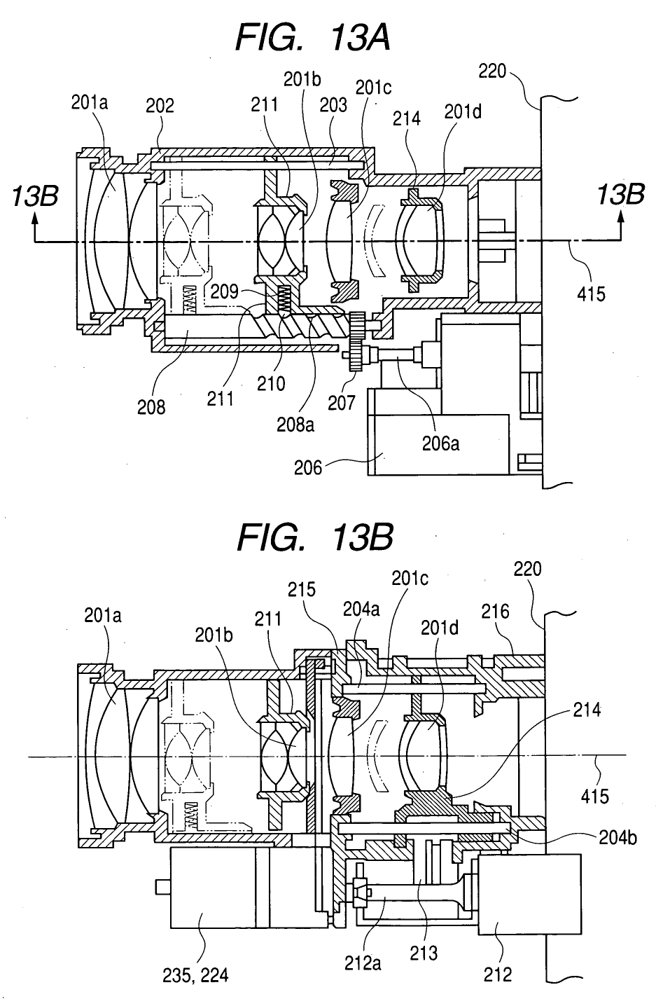

FIGS. 13A and 13B show a configuration of a zoom lens barrel (optical apparatus) for a video camera having a four-group lens configuration including a stop unit having a light quantity regulator in an embodiment of the present invention. FIG. 13B shows a sectional view taken along the line 13B-13B in FIG. 13A.

Four lens groups 201a to 201d constituting the zoom lens are respectively constituted by a fixed plano-convex lens 201a, a variator lens group 201b for performing the power varying operation by moving along the optical axis, fixed afocal lens 201c and a focusing lens group 201d for keeping a focus plane and performing focusing at the time of power varying by moving along the optical axis.

Guide bars 203, 204a and 204b are arranged in parallel with an optical axis 205 to perform guide and whirl-stop of a moving lens group. A DC motor 206 serves as a driving source for moving the variator lens group 201b.

The plano-convex lens 201a is held by a plano-convex lens barrel 202 and the variator lens group 201b is held by a V-movement annulus 211. Moreover, the afocal lens 201c is held by an intermediate frame 215 and the focusing lens group 201d is held by an RR-movement annulus 214.

The plano-convex lens barrel 202 is positioned and fixed to a rear lens barrel 216, the guide bar 203 is positioned and held by both the lens barrels 202 and 216 and a guide screw shaft 208 is rotatably supported. The guide screw shaft 208 is rotated when the rotation of the output shaft 206a of the DC motor 206 is conducted through a gear string 207.

The V-movement annulus 211 for holding the variator lens group 201b has a pressing spring 209 and a ball 210 engaged with a screw groove 208a formed on the guide screw shaft 208 by the force of the pressing spring 209, which is advanced or backed in the optical axis direction while it is guided and rotation-controlled by the guide bar 203 when the guide screw 208 is rotated by the DC motor 206.

The guide bars 204a and 204b are fitted to and supported by the rear lens barrel 216 and the intermediate frame 215 positioned to the rear lens barrel 216. The RR-movement annulus 214 can be advanced or backed in the optical axis direction while being guided and rotation-controlled by these guide bars 204a and 204b.

A stop unit 235 (motor 224) of the above embodiment is set to the intermediate frame 215. Thereby, the stop unit 235 is set between the variator lens group 201b and the afocal lens 201c.

A sleeve portion slidably fitted to the guide bars 204a and 204b is formed on the RR-movement annulus 214 for holding the focusing lens group 201d and a rack 213 is set so as to be integrated with the RR-movement annulus 214 in the optical axis direction.

A stepping motor 212 rotates a lead screw 212a integrally formed on the output shaft of the motor 212. The rack 213 set to the RR-movement annulus 214 is engaged with the lead screw 212a. When the lead screw 212a rotates, the RR-movement annuls 214 moves in the optical axis direction while it is guided by the guide bars 204a and 204b.

It is allowed to use a stepping motor as the driving source of the variator lens group similarly to the case of the driving source of the focusing lens group.

Moreover, a lens barrel body is formed which substantially seals and houses a lens and the like by the plano-convex lens barrel 202, intermediate frame 215 and rear lens barrel 216.

Furthermore, when moving the lens-group holding frame by using the stepping motor, the absolute position of the holding frame is detected by detecting that the holding frame is located at a reference position in the optical axis direction by a photointerrupter and then continuously counting the number of driving pulses to be supplied to the stepping motor.

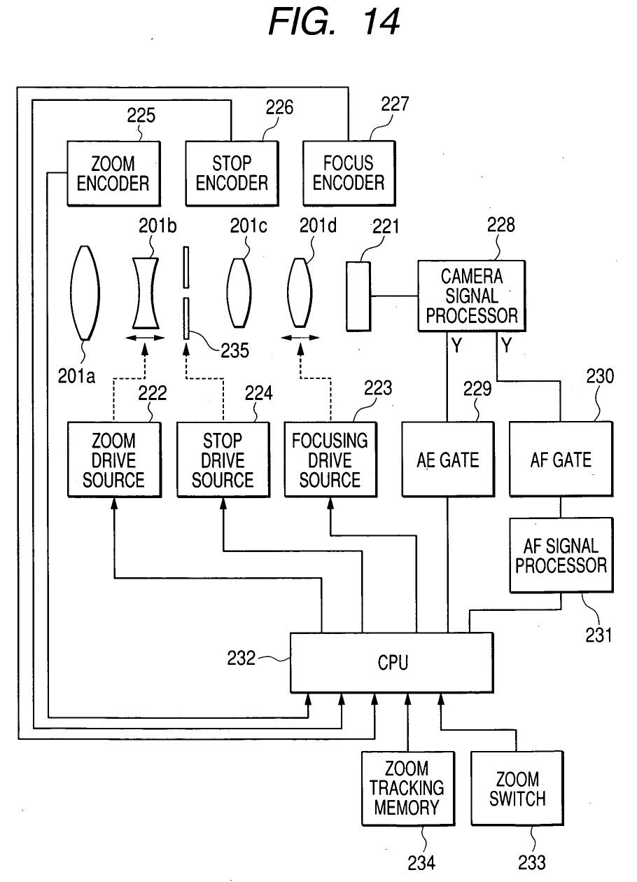

FIG. 14 shows an electrical configuration of a camera body of a photographing apparatus having a zoom lens barrel described in FIGS. 13A and 13B as a photographing optical system. In FIG. 14, components of the lens barrel described for FIGS. 13A and 13B are provided with the same symbols as those in FIGS. 13A and 13B.

Reference numeral 221 denotes a solid-state image pickup device such as a CCD and 222 denotes the driving source of the variator lens group 201b, which includes the motor 206 (or stepping motor), gear string 207 and guide screw shaft 208.

Reference numeral 223 denotes the driving source of the focusing lens group 201d, which includes the stepping motor 212, lead screw shaft 212a and rack 213.

Reference numeral 224 denotes a motor serving as the driving source of the stop unit 235 of the above embodiment, which is set between the variator lens group 201b and the afocal lens 201c.

Reference numeral 225 denotes a zoom encoder and 227 denotes a focus encoder. These encoders respectively detect the optical-axis-directional absolute position of the variator lens group 201b and focusing lens group 201d. When using the DC motor shown in FIGS. 13A and 13B as a variator driving source, an absolute position encoder such as a volume or a magnetic type is used.

Moreover, when using a stepping motor as a driving source, it is general to set a holding frame to the above-described reference position and then use a method for continuously counting the number of operation pulses input to a stepping motor.

Reference numeral 226 denotes a stop encoder which uses an encoder in which a hall element is set in the stop driving source 224 of a motor to detect a rotation-positional relation between a rotor and a stator.

Reference numeral 232 denotes a CPU for controlling this camera. Reference numeral 228 denotes a camera signal processing circuit which applies predetermined amplification and gamma correction to an output of the solid-state image pickup device 221. A contrast signal of an image signal undergoing these predetermined processings passes through an AE gate 229 and an AF gate 230. That is, an optimum signal fetching range for exposure decision and focusing is set by the gates in the whole screen. The size of each gate is variable and a plurality of gates may be set.

Reference numeral 231 denotes an AF signal processing circuit for processing an AF signal for AF (auto focus), which generates one or more outputs about the high-frequency component of an image signal. Reference numeral 233 denotes a zoom switch and 234 denotes a zoom tracking memory.

The zoom tracking memory 234 stores the information on a focusing lens position to be set in accordance with an object distance and a variator lens position for power varying. It is also allowed to use a memory in the CPU 232 as the zoom tracking memory.

For example, when a zoom switch 233 is operated by a photographer, the CPU 232 drives and controls the zoom driving source 222 and focusing driving source 223 so that a predetermined positional relation between a variator lens and a focusing lens calculated in accordance with the information in the zoom tracking memory 234 is kept and the present optical-axis-directional absolute position of the variator lens serving as a detection result of the zoom encoder 225 and a calculated position of the variator lens to be set coincide with each other, and the present optical-axis-directional absolute position of the focus lens serving as a detection result of the focus encoder 227 and a calculated position of the focus lens to be set coincide with each other.

The CPU 232 drives and controls the focusing driving source 223 so that an output of the AF signal processing circuit 231 shows a peak in the auto focus operation. Moreover, to obtain a proper exposure, the CPU 232 drives and controls the stop driving source 224 so that an output of the stop encoder 226 becomes a predetermined value which is the average value of Y-signal outputs passing through the AE gate 229 to control the opening diameter of the stop unit 235.

Though a lens barrel of a vide camera is described above, the present invention can be also applied to a stationary-image camera and other image pickup apparatuses and lens barrels for these.

### EMBODIMENTS

Then, embodiments of the present invention will be described below.

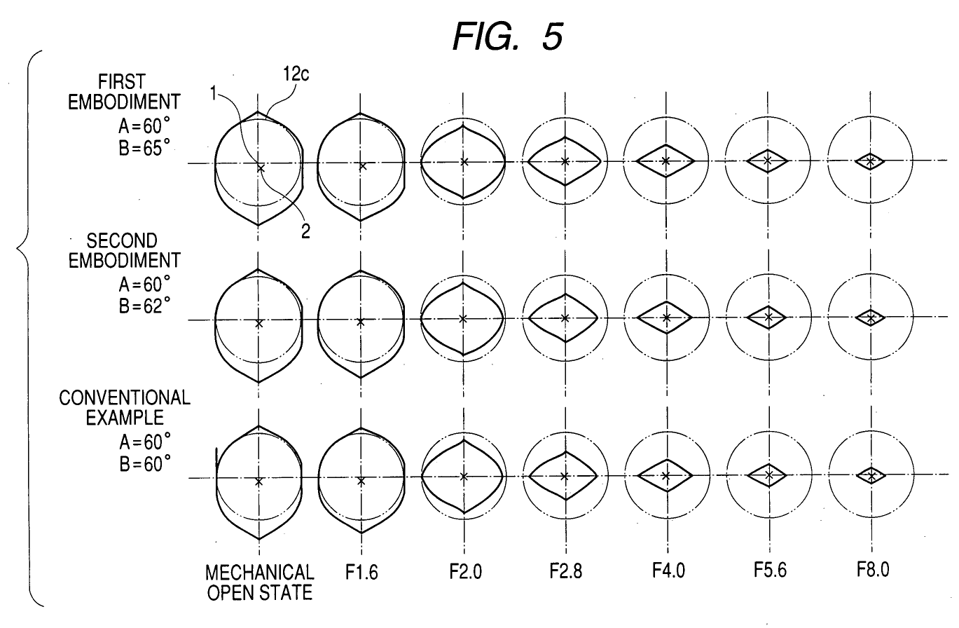

In FIG. 5, two embodiments are described which set apex angles by an opening-shape-portion angles A and B of light passing ports of both light shielding vanes of the stop apparatus of the above embodiment in a certain optical apparatus and a change of opening shapes of the light passing port and a change of centers of gravities of the opening area. Moreover, an example using the technique of the present invention disclosed in Japanese Patent Application Laid-Open No. 2002-182264 of prior art is shown as a comparative example.

In any example, the lower opening shape when a mechanism is opened is set so as to be further separate from the optical axis 1 compared to the upper opening shape. Therefore, the opening-area center of gravity 2 is greatly displaced below from the optical axis 1 from the time when the mechanism is opened to F1.6 in order to restrain the displacement of the opening-area center of gravity 2 from the optical axis 1 from an intermediate stop region to a small stop region as disclosed in Japanese Patent Application Laid-Open No. 2002-182264. When the mechanism is opened, the fixed stop 12c formed on the bottom board of the stop apparatus is present as described above. Therefore, it can be said that there is no influence on optical performances of an optical apparatus such as an actual lens barrel.

The first embodiment in FIG. 5 is an example in which apex angles of light shielding vanes of the embodiment are set to A=60° and B=65°. In this case, the opening-area center of gravity 2 is kept while it substantially coincides with the optical axis 1 and the opening shape is substantially symmetric to the optical axis in the vertical and horizontal directions in the small-stop-side region from F2.8. However, at F2.0, the opening-area center of gravity is shifted to right from the optical axis.

The second embodiment is an example in which apex angles of light shielding vanes of the embodiment are set to A=60° and B=62°. The displacement of the opening-area center of gravity from the optical axis in a small stop-side region from F2.8 and improved value of asymmetry of the opening shape are small compared to the case of the embodiment 1. However, the opening-area center of gravity substantially coincides with the optical axis at F2.0.

In the case of any of the above embodiments, the horizontal displacement of the opening-area center of gravity from the optical axis and asymmetry of the opening shape caused when the opening area is changed from an opened state to a small stop region are improved compared to the case of the conventional example.

As shown by the above embodiment, it is possible to set a point for improving the asymmetry of the opening shape of the light passing port and the displacement of the opening-area center of gravity in attaching importance to a position nearby the intermediate stop and set the point in further attaching importance to the small stop side by selecting the setting of the apex angle of the opening in accordance with the configuration and characteristic of a stop apparatus or optical apparatus used.

According to the present invention, when two light shielding vanes open or close between an opened state and a fully closed state, it is possible to realize a light quantity regulator, optical apparatus and a photographing apparatus capable of eliminating the asymmetry of the opening shape of a light passing port formed by these light shielding vanes to the optical axis or eccentricity of the opening-area center of gravity of the light passing port and improving optical characteristics. Particularly, the present invention is effective for a vane-oscillation-type stop apparatus and it is possible to realize a compact light quantity regulator having less influence on optical performances, an optical apparatus mounting the light quantity regulator and a photographing apparatus.

As many apparently widely different embodiments of the present invention can be made without departing from the spirit and scope thereof, it is to be understood that the invention is not limited to the specific embodiments thereof except as defined in the claims.

This application claims priority from Japanese Patent Application No. 2003-408507 filed on Dec. 8, 2003, which is hereby incorporated by reference herein.

1. A light quantity regulator used for an optical apparatus, comprising:
a bottom board;
two light shielding vanes which form an opening for passing light; and
a driving lever connected to the two light shielding vanes and supported to the bottom board by a shift, which rotates about the shaft and drives the two light shielding vanes in directions opposite to each other so as to adjust an opening area of the opening from an opened state to a closed state,
wherein the opening in the opened state has a shape asymmetric to an optical axis.

2. The light quantity regulator according to claim 1, further comprising:
a guide groove formed on one of a light shielding vane and a bottom board and a guide shaft set to the other of the light shielding vane and the bottom board and
a guide member for guiding the movement of the light shielding vane.

3. The light quantity regulator according to claim 1, wherein
the opening in which an opening area is smaller than that of the opened state has a shape substantially symmetric to the optical axis.

4. The light quantity regulator according to claim 1, wherein
the opening-area center of gravity of the opening in the opened state almost coincides with the optical axis.

5. The light quantity regulator according to claim 1, wherein
at least one light shielding vane has an ND filter.

6. A light quantity regulator used for an optical apparatus, comprising:
a bottom board;
two light shielding vanes which respectively have an opening margin for forming an opening for passing light;
a driving lever connected to the two light shielding vanes and supported to the bottom board by a shift, which rotates about the shaft and drives the two light shielding vanes in directions opposite to each other so as to adjust an opening area of the opening,
wherein each of the opening margins has an apex angle and a straight line connecting the apex angles intersects with an optical axis.

7. The light quantity regulator according to claim 6, wherein
at least one opening margin is not line-symmetric to the straight line.

8. The light quantity regulator according to claim 6, wherein
at least one opening margin has a first region and a second region, the angle formed by the straight line and the first region is different from the angle formed by the straight line and the second region.

9. The light quantity regulator according to claim 6, further comprising:
a guide groove formed on one of a light shielding vane and a bottom board, a guide shaft set to the other of the light shielding vane and bottom board and a guide member for guiding the movement of the light shielding vane.

10. The light quantity regulator according to claim 6, wherein
at least one light shielding vane has an ND filter.

11. An optical apparatus comprising an optical system having the light quantity regulator of claim 1.

12. An optical apparatus comprising an optical system having the light quantity regulator of claim 6.

13. A photographing apparatus comprising a photographing optical system having the light quantity regulator of claim 1.

14. A photographing apparatus comprising a photographing optical system having the light quantity regulator of claim 6.
